(19) United States
(12) Patent Application Publication
(10) Pub. No.: US 2025/0207399 A1
(43) Pub. Date: Jun. 26, 2025

(54) RUBBER ROOFING MEMBRANES WITH LIGNIN

(71) Applicant: Holcim Technology Ltd, Zug (CH)

(72) Inventors: Zengquan QIN, Brentwood, TN (US); Donna C. TIPPMANN, Nashville, TN (US); Jiansheng TANG, Westfield, IN (US); Andrew KINNAIRD, Nashville, TN (US)

(21) Appl. No.: 19/073,812

(22) Filed: Mar. 7, 2025

Related U.S. Application Data
(63) Continuation of application No. PCT/US2023/032403, filed on Sep. 11, 2023.
(60) Provisional application No. 63/404,989, filed on Sep. 9, 2022.

(51) Int. Cl. E04D 5/08; C08J 5/18; C08L 23/16

(52) U.S. Cl. CPC E04D 5/08; C08J 5/18; C08L 23/16; C08J 2323/16; C08J 2497/00

(57) ABSTRACT

A roof system comprising a roof deck, and a membrane secured to the roof deck, where the membrane is an EPDM membrane including at least two cured layers of EPDM rubber, where at least one of the at least two cured layers includes lignin dispersed therein.

This application is a U.S. continuation-in-part application of PCT/US2023/032403 filed on Sep. 11, 2023, which claims the benefit of U.S. provisional application No. 63/404,989 filed on Sep. 9, 2022, which are incorporated herein by reference.

### FIELD OF THE INVENTION

The present invention generally relates to EPDM roofing membranes that include lignin.

### BACKGROUND OF THE INVENTION

Single-ply roofing membranes fabricated from ethylene-propylene-diene terpolymer (EPDM rubber) are widely used to cover flat or low-sloped roofs. Among the several characteristics that these membranes must exhibit in order to function as a roofing membrane is flame resistance. In this respect, roof systems that including single-ply membranes such as EPDM roofing membranes are classified by ASTM E108 (2020) or similar standards such as UL 790 (2014). These classification methodologies include multiple tests that ultimately provide a rating (i.e. Class A, B or C), which suggests the flame resistance of the system. Specifically, where membrane systems are installed over a non-combustible deck, the system is only subjected to the spread of flame test, while membrane systems installed over a combustible desk are subjected to the spread of flame test, the intermittent flame test, and the burning brand test.

While several factors, such as the nature of the deck, play into the ultimate classification, the flame resistance of the EPDM membrane may play a major role in the fire resistance of the system. The flame resistance of EPDM membranes was historically achieved by the addition of flame retardants such halogenated compounds (e.g. decabromodiphenyl oxide). More recently, EPDM membranes with advantageous flame resistance have been achieved by the addition of mineral fillers such as clay, talc, and mica. While useful, limitations exist with regard to the flame resistance of these mineral-filled membranes. That is, there are limits to the level of mineral filler that can be included within the membrane because the mechanical properties of the membrane are deleteriously impacted at higher loadings of these fillers. This is especially problematic for non-reinforced membranes. As a result, advantageous fire ratings are difficult to achieve for roof systems with higher slopes (e.g. 3:12 as opposed to 0.25:12 pitched roofs).

### SUMMARY OF THE INVENTION

One or more embodiments of the present invention provide a roof system comprising a roof deck, and a membrane secured to the roof deck, where the membrane is an EPDM membrane including at least two cured layers of EPDM rubber, where at least one of the at least two cured layers includes lignin dispersed therein.

Other embodiments of the present invention provide a roofing membrane comprising a cured EPDM rubber matrix having lignin dispersed therein.

Yet other embodiments of the present invention provide a roof system including a roofing membrane comprising a cured EPDM rubber matrix having lignin dispersed therein.

Still other embodiments of the present invention provide a method of forming a roofing membrane; the method comprising (i) preparing a vulcanizable composition including EPDM rubber and from about 0.5 to about 30 parts by weight lignin per 100 parts by weight rubber; (ii) forming the vulcanizable composition into a green membrane sheet; and (iii) curing the green membrane sheet

### DETAILED DESCRIPTION OF ILLUSTRATIVE EMBODIMENTS

Embodiments of the present invention are based, at least in part, upon the discovery of an EPDM roofing membrane including lignin. Advantageously, the membranes of one or more embodiments demonstrate improved flame resistance and can therefore provide roof systems with advantageous ratings under ASTM E108 (2020) (20A) (and/or UL 790 (2014)). Additionally, the improved flame resistance has been realized without a deleterious impact on other characteristics of the membrane, and therefore membranes of this invention meet the performance standards of ASTM D4637 (2021). While the prior art contemplates EPDM membranes that can achieve Class A (ASTM E108 (2020) and/or UL 790 (2014)) over a non-combustible deck by including threshold amounts of mineral filler, it has been discovered that the same or better flame resistance can be achieved with lignin with decreased impact on membrane properties relative to mineral fillers.

### Membrane Construction

As suggested above, the membranes of this invention, which may also be referred to as membrane panels, are EPDM roofing membranes, which generally include a planar body formed from a cured rubber matrix in which other constituents, such as the lignin, may be dispersed. The membranes may be of a type generally classified as single-ply roofing membranes, and they are therefore adapted to provide a weatherproof exterior surface to a roofing system. The membranes may optionally include a fabric reinforcement (e.g. scrim) embedded within the membrane; i.e. the fabric is sandwiched between rubber layers. In other embodiments, the membranes are without fabric reinforcement. In one or more embodiments, the EPDM sheet meets the performance standards of ASTM D4637 (2021).

In one or more embodiments, the membranes may be characterized by a thickness of greater than 20, in other embodiments greater than 40, and in other embodiments greater than 50 mils. In these or other embodiments, the membranes are characterized by a thickness of less than 120, in other embodiments less than 100, and in other embodiments less than 90 mils. In one or more embodiments, the membranes have a thickness of from about 20 to about 100 mils, in other embodiments from about 35 to about 95 mils, and in other embodiments from about 45 to about 90 mils. In one or more embodiments, the membranes may be characterized by a width of greater than 5, in other embodiments greater than 10, in other embodiments greater than 20, and in other embodiments greater than 30 feet. In these or other embodiments, the membranes are characterized by a width of less than 100, in other embodiments less than 80, and in other embodiments less than 60 feet. In one or more embodiments, the membranes have a width of from about 5 to about 100, in other embodiments from about 10 to about 100, in other embodiments from about 20 to about 80, and in other embodiments from about 30 to about 60 feet.

In one or more embodiments, the membranes, although commonly referred to as single-ply roofing membranes, may include two or more rubber layers that are mated together with an optional scrim disposed between the layers. In particular embodiments, the respective layers may be compositionally distinct. For example, first and second rubber sheets (i.e. layers) may be formed from first and second respective rubber compositions, and then the respective sheets can be mated and further calendered or laminated to one another, optionally with a reinforcing fabric therebetween. The skilled person will recognize, however, that these layers may be integral to the extent that the calendering and/or curing process creates an interface, at some level, and the layers are generally inseparable. Nonetheless, reference can be made to the individual layers, especially where the layers derive from distinct compositions. Reference may also be made a multi-layered sheet. Relative to the overall thickness, the thickness of the respective layers (regardless of whether or not they are compositionally distinct), may vary. In one or more embodiments, the thickness of the individual layers of a membrane panel including two rubbers layers may be half or approximately half of the overall thickness less any increase in thickness resulting from the scrim.

In one or more embodiments, each layer of a multi-layered membrane or sheet may include lignin according to the present invention. In other embodiments, a first layer may include lignin and a second layer is devoid or substantially devoid of lignin. Substantially devoid refers to the absence of that amount of lignin that would otherwise have an appreciable impact on practice of the present invention. For example, in one embodiment, the membrane of the invention is a calendered sheet wherein a first composition including lignin is calendared to form a first layer of the membrane, and a second composition that devoid or substantially devoid of lignin is calendared to form a second layer of the membrane.

In one or more embodiments, the membranes of the present invention are two-layered membranes, wherein the first membrane is black in color and the second layer is non-black in color (e.g. white or generally white). As those skilled in the art appreciate, the black layer can derive from a black composition that would generally include carbon black as a filler. The black layer includes lignin as contemplated by the present invention. The white layer can derive from a white composition that would generally include non-black fillers such as silica, titanium dioxide, and/or clay. White EPDM membranes or membranes having a white EPDM layer are known in the art as disclosed in U.S. Pat. No. 8,367,760, which is incorporated herein by reference.

### Membrane Composition

The composition of the membranes of this invention can be understood with reference to the constituents of the vulcanizable (i.e. curable) composition used to form the membranes. As will be described in greater detail below, the vulcanizable composition is formed and shaped into the desired shape of the membrane, and then the membrane is cured to form the cured rubber matrix in which the other constituents, such as the lignin, are dispersed. The skilled person also understands that a membrane may be constructed by combining two or more layers (typically prior to curing), and each layer may derive from separate vulcanizable compositions. Where the membranes of this invention are prepared by combining multiple rubbers layers, at least one of the layers may include lignin according to embodiments of this invention. The other layers may be conventional in nature and are adapted to be compatible with the one or more layers including the lignin. In particular embodiments, the one or more of the other layers may be devoid of lignin.

In one or more embodiments, the vulcanizable compositions include EPDM, a curative for the EPDM, lignin, and a filler. Additionally, the vulcanizable compositions may optionally include and extender, oil, wax, antioxidant, antiozonant, and a combination of two or more thereof. In particular embodiments, the vulcanizable compositions are devoid of halogenated compounds, particularly halogenated flame retardants. In particular embodiments, the vulcanizable compositions include a complementary flame retardant. In sub embodiments thereof, the complementary flame retardant is a non-halogenated flame retardant.

### EPDM Rubber

The skilled person understands that EPDM refers to an olefinic terpolymer rubber polymer (which may also be referred to as a curable polymer or an elastomeric terpolymer). In one or more embodiments, the olefinic terpolymer includes mer units that derive from ethylene, α-olefin, and optionally diene monomer. Useful α-olefins include propylene. In one or more embodiments, the diene monomer may include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-vinyl-2-norbornene, 5-n-propylidene-2-norbornene, 5-(2-methyl-2-butenyl)-2-norbornene, and mixtures thereof. Olefinic terpolymers and methods for their manufacture are known as disclosed at U.S. Pat. No. 3,280,082 as well as U.S. Publication No. 2006/0280892, both of which are incorporated herein by reference. Furthermore, olefinic terpolymers and methods for their manufacture as related to non-black membranes are known as disclosed in U.S. Pat. Nos. 8,367,760, 9,915,069, and 8,791,193, which are also incorporated herein by reference. For purposes of this specification, elastomeric terpolymers may simply be referred to as EPDM or EPDM rubber.

In one or more embodiments, the elastomeric terpolymer may include greater than 50 wt %, in other embodiments greater than 55 wt %, and in other embodiments greater than 64 wt % mer units deriving from ethylene; in these or other embodiments, the elastomeric terpolymer may include less than 75 wt %, and in other embodiments less than 71 wt % mer units deriving from ethylene. In one or more embodiments, the elastomeric terpolymer may include greater than 1.2 wt %, in other embodiments greater than 2.0 wt % mer units deriving from diene monomer; in these or other embodiments, the elastomeric terpolymer may include less than 8 wt %, in other embodiments less than 6 wt %, and in other embodiments less than 4 wt % mer units deriving from diene monomer. In one or more embodiments, the balance of the mer units derive from propylene or other α-olefins. The elastomeric terpolymers may be characterized and include cure systems as is known in the art and as disclosed in U.S. Publication No. 2006/0280892, incorporated herein by reference.

As is known in the art, it is within the scope of the present invention to blend low Mooney EPDM terpolymers with high Mooney EPDM terpolymers to reduce the overall viscosity of the membrane compound. In other words, EPDM terpolymers with different molecular weights may be utilized to accommodate processing.

### Curative

As indicated above, the vulcanizable composition includes a curative that serves to cure or crosslink the rubber. Those skilled in the art appreciate that EPDM can be cured by using numerous techniques such as those that employ sulfur cure systems, peroxide cure systems, and quinone-type cure systems. The sulfur cure systems may be employed in combination with vulcanizing accelerators.

In one or more embodiments, sulfur and sulfur-containing cure systems may be used (optionally together with an accelerator). Suitable amounts of sulfur can be readily determined by those skilled in the art. In one or more embodiments from about 0.5 to about 2.5 part by weight (pbw) sulfur per 100 parts by weight rubber (phr) may be used. The amount of accelerator can also be readily determined by those skilled in the art.

Useful vulcanizing accelerators include thioureas such as ethylene thiourea, N,N-dibutylthiourea, N,N-diethylthiourea and the like; thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH) and the like; benzothiazole sulfenamides such as N-oxydiethylene-2-benzothiazole sulfenamide, N-cyclohexyl-2-benzothiazole sulfenamide, N,N-diisopropyl-2-benzothiazolesulfenamide, N-tert-butyl-2-benzothiazole sulfenamide (TBBS), and the like; other thiazole accelerators such as 2-mercaptobenzothiazole (MBT), benzothiazyl disulfide (MBTS), N,N-diphenylguanidine, N,N-di-(2-methylphenyl)-guanidine, 2-(morpholinodithio)benzothiazole disulfide, zinc 2-mercaptobenzothiazole and the like; dithiocarbamates such as tellurium diethyldithiocarbamate, copper dimethyldithiocarbamate, bismuth dimethyldithiocarbamate, cadmium diethyldithiocarbamate, lead dimethyldithiocarbamate, sodium butyldithiocarbamate, zinc diethyldithiocarbamate, zinc dimethyldithiocarbamate, zinc dibutyldithiocarbamate (ZDBDC), dithiophosphates, and mixtures thereof. Sulfur donor-type accelerators (e.g. di-morpholino disulfide and alkyl phenol disulfide) may be used in place of elemental sulfur or in conjunction with elemental sulfur if desired.

Examples of suitable peroxides that can be used as curing agents or co-curing agents include alpha-cumyl hydroperoxide, methylethylketone peroxide, hydrogen peroxide, acetylacetone peroxide, t-butyl hydroperoxide, t-butyl peroxybenzoate, 2,5-bis(t-butyl peroxy)-2,5-dimethylhexene, lauryl peroxide, benzoyl peroxide, 2,4-dichlorobenzoyl peroxide, dibenzoyl peroxide, bis(p-monomethylene-benzoyl) peroxide, bis(p-nitrobenzoyl) peroxide, phenylacetyl peroxide, and mixtures thereof.

Examples of inorganic peroxides that can be used as co-curing agents with p-quinone dioxime include lead peroxide, zinc peroxide, barium peroxide, copper peroxide, potassium peroxide, silver peroxide, sodium peroxide, calcium peroxide, metallic peroxyborates, peroxychromates, peroxydicarbonates, peroxydiphosphates, peroxydisulfates, peroxygermanates, peroxymolybdates, peroxynitrates, magnesium peroxide, sodium pyrophosphate peroxide, and mixtures thereof.

Examples of polysulfide activators for the quinone-type co-curing agents include calcium polysulfide, sodium polysulfide, as well as organic polysulfides having the general formula R—(S)ₓ—R, wherein R is a hydrocarbon group and x is a number from 2-4. Examples of organic polysulfides are disclosed in U.S. Pat. No. 2,619,481, which is incorporated herein by reference.

Where radiation curing is employed to crosslink the rubber, an ionizing crosslinking promoters may be included in lieu of or in addition to the curatives described above. These ionizing crosslinking promoters may include, but are limited to, liquid high-vinyl 1,2-polybutadiene resins containing 90 percent 1,2-vinyl content, ethylene glycol dimethacrylate, dicumyl peroxide (typically about 98 percent active), and pentaerythritol resin prepared from tall oil.

### Lignin

As indicated above, the vulcanizable composition includes lignin. The skilled person understands that lignin is a plant-based polymeric material that is derived by reacting lignols, which are also referred to monolignols, which are the phenolic precursors to forming lignin. The most common phenolic precursors include (i) coniferyl alcohol (4-hydroxy-3-methoxyphenylpropoane)(guaiacyl); (ii) paracoumaryl alcohol (4-hydroxyphenylpropane)(4hydroxyphenyl); and (iii) sinapyl alcohol (3,5-dimethoxy-4 -hydroxyphenylpropane)(syringyl). Lignin can be found in plant biomass in the cell wall along with cellulose, hemicellulose, and pectin. Plant biomass includes wood (trees and bushes), wood residues, agricultural crops (starch-producing, oil-producing, etc.), agricultural residues, agricultural waste, and other wastes and residues. Residues and waste are by-products of plant materials harvested for other purposes.

The lignin employed in the practice of this invention can be obtained as a by-product of the papermaking industry through pulping processes used to remove lignin from cellulose. These processes may be referred to as delignification processes and can include solvent processes and chemical processes such as sulfite pulping and kraft (alkaline) processes. Sulfite pulping results in lignosulfonates. The kraft process creates kraft lignin in the pulping liquors. Solvent processes are known to produce organosolv lignin as described in U.S. Pat. No. 3,585,104 A, which is incorporated herein by reference.

In one or more embodiments, useful lignin includes technical lignin, which is isolated from various biomass during pulping processes and includes lignosulphonates (isolated from sulfite pulping), kraft lignins (isolated from kraft pulping black liquor), organosolv lignins (isolated from organosolv pulping), soda lignins (isolated from soda pulping), and lignin residue after enzymatic treatment of biomass.

Useful lignin may be obtained commercially from a variety of sources. For example, useful lignin may be obtained under the tradename BioChoice® Lignin (Domtar).

In one or more embodiments, lignin may be characterized by its physical form. For example, the lignin may be in the form of a powder, the powder may be in a wet or dry form. In one or more embodiments, the lignin is in the form of granules. In one or more embodiments, the lignin is in the form of pellets.

The lignin employed in the present invention may be characterized by its moisture content. In one or more embodiments, the lignin has a moisture content of less than 50% by weight, in other embodiments less than 35% by weight, in other embodiments less than 20% by weight, in other embodiments less than 10% by weight, in other embodiments less than 5% by weight, in other embodiments less than 2% by weight, and in other embodiments less than 1% by weight.

The lignin employed in the present invention may be characterized by its lignin content. In one or more embodiments, the lignin has a lignin content of greater than 65% by weight, in other embodiments greater than 70% by weight, in other embodiments greater than 75% by weight, in other embodiments greater than 80% by weight, in other embodiments greater than 85% by weight, in other embodiments greater than 90% by weight, in other embodiments greater than 95% by weight, in other embodiments greater than 98% by weight, and in other embodiments the lignin has a lignin content of greater than 99% by weight.

The lignin employed in the present invention may be characterized by its ash content. In one or more embodiments, the lignin has less than 1.0% by weight ash.

The lignin employed in the present invention may be characterized by its particle size, which can be measured by laser diffraction using the methodologies of ASTM E2651 (2019). In one or more embodiments, the lignin has a D₉₀ particle size of less than 300 μm, in other embodiments less than 250 μm, in other embodiments less than 200 μm, in other embodiments less than 150 μm, in other embodiments less than 125 μm, in other embodiments less than 100 μm, in other embodiments less than 75 μm, in other embodiments less than 50 μm, in other embodiments less than 35 μm, and in other embodiments less than 20 μm.

In one or more embodiments, functionalized lignin, which may also be referred to as modified lignin, can be used. As the skilled person appreciates, lignin can be modified with one or more functional groups through amination, demethylation, demethoxylation, phenolation, sulfonation, nitration, phosphorylation, epoxidation, acylation, sulfomethylation, esterification, oxyalkylation, methylation, and depolymerization. In one or more embodiments, the lignin is reacted with a modifying agent to increase the hydrophobicity of the lignin and thereby increase its compatibility with olefinic rubber, such as EPDM. This reaction can, for example, be accomplished by reacting the modifying agent with the hydroxyl groups of the lignin. For example, lignin can be reacted with alkyl ketene dimer (AKD) or alkyl succinic anhydride (ASA). In one or more embodiments, this reaction can take place prior to introducing the lignin to the rubber formulations of this invention (i.e. pre-modified or pre-functionalized lignin). In other embodiments, a modifying agent can be added to the rubber formulation (to which lignin is also introduced), and the lignin can be modified is situ (i.e. the modification of the lignin takes place while the lignin is mixed with the rubber). The skilled person will be able determine the appropriate amount of functionalizing agent to react with or otherwise combine with the lignin without undue experimentation or calculation. For example, a desired amount of functionalization can be achieved by reacting a molar equivalent of functionalizing agent to hydroxyl groups associated with the lignin. The moles of hydroxyl groups (also referred to as functionality) of the lignin is often reported with commercially-available lignin or can be easily determined by standard analytical techniques.

### Complementary Flame Retardants

As mentioned above, the lignin may optionally be used in conjunction with a complementary flame retardant. Flame retardants those compounds that increases the burn resistivity of the EPDM membranes.

Useful complementary flame retardants include char-forming and decomposition flame retardants. Those skilled in the art understand that char-forming flame retardants operate by forming a char-layer across the surface of a specimen when exposed to a flame. Decomposition flame retardants, on the other hand, operate by releasing water (or other flame extinguishing compound) upon thermal decomposition of the flame retardant compound. As indicated above, the complementary flame retardants may also be categorized as halogenated flame retardants or non-halogenated flame retardants.

Exemplary non-halogenated flame retardants that may be used as complementary flame retardants include magnesium hydroxide, aluminum trihydrate, zinc borate, ammonium polyphosphate, melamine polyphosphate, antimony oxide (Sb₂O₃), and expandable graphite. Ammonium polyphosphate may be used together as a polyol masterbatch. Those flame retardants from the foregoing list that are believed to operate by forming a char layer include ammonium polyphosphate and melamine polyphosphate.

### Filler

As mentioned above, the vulcanizable compositions of the present invention may include filler. These fillers may include those conventionally employed in the art, as well as combinations of two or more of these fillers. In one or more embodiments, the filler may include carbon black. Examples of useful carbon blacks include those generally characterized by average industry-wide target values established in ASTM D-1765 (2021). Exemplary carbon blacks include GPF (General-Purpose Furnace), FEF (Fast Extrusion Furnace), and SRF (Semi-Reinforcing Furnace). One particular example of a carbon black is N650 GPF Black, which is a petroleum-derived reinforcing carbon black having an average particle size of about 60 nm and a specific gravity of about 1.8 g/cc. Another example is N330, which is a high abrasion furnace black having an average particle size about 30 nm, a maximum ash content of about 0.75%, and a specific gravity of about 1.8 g/cc.

Other useful fillers including clay and talc, such as those disclosed in U.S. Publication No. 2006/0280892, which is incorporated herein by reference. Still other useful fillers include silica, which may be used in conjunction with a coupling agent as disclosed, for example, in U.S. Publication Nos. 2015/0038031 and 2018/0179759, which are incorporated herein by reference.

### Extenders

As mentioned above, the vulcanizable compositions of the present invention may optionally include extenders. Useful extenders include paraffinic, naphthenic oils, and mixtures thereof. These oils may be halogenated as disclosed in U.S. Pat. No. 6,632,509, which is incorporated herein by reference. In one or more embodiments, useful oils are generally characterized by, low aromaticity, low volatility and a flash point of more than about 550° F. Useful extenders are commercially available. One particular extender is a paraffinic oil available under the tradename SUNPAR™ 2280 (Sun Oil Company). Another useful paraffinic process oil is Hyprene P150BS, available from Ergon Oil Inc. of Jackson, MS.

### Other Constituents

In addition to the foregoing constituents, the vulcanizable composition of this invention may also optionally include mica, coal filler, ground rubber, titanium dioxide, calcium carbonate, silica, homogenizing agents, phenolic resins, flame retardants, zinc oxide, stearic acid, and mixtures thereof as disclosed in U.S. Publication No. 2006/0280892, which is incorporated herein by reference. Certain embodiments may be substantially devoid of any one or more of these constituents.

### Amounts

In one or more embodiments, the vulcanizable compositions used to prepare the one or more layers of the membranes of this invention (which include lignin) include from about 20 to about 50, in other embodiments from about 24 to about 36, and in other embodiments from about 28 to about 32% by weight rubber (e.g., EPDM) based on the entire weight of the membrane.

In one or more embodiments, the vulcanizable compositions used to prepare the one or more layers of the membranes of this invention include greater than 0.5 parts by weight (pbw), in other embodiments greater than 1 pbw, in other embodiments greater than 2 pbw, in other embodiments greater than 3 pbw, in other embodiments greater than 5 pbw, and in other embodiments greater than 10 pbw lignin per 100 parts by weight rubber (phr). In these or other embodiments, the vulcanizable compositions of this invention include less than 100 pbw, in other embodiments less than 80 pbw, in other embodiments less than 50 pbw, in other embodiments less than 30 pbw, in other embodiments less than 28 pbw, in other embodiments less than 25 pbw, in other embodiments less than 20 pbw, in other embodiments less than 18 pbw, and in other embodiments less than 15 pbw lignin phr. In one or more embodiments, the vulcanizable compositions used to prepare the one or more layers of the membranes of this invention include from about 2 to about 100, in other embodiments from about 5 to about 80, in other embodiments from about 8 to about 60, in other embodiments from about 10 to about 50, in other embodiments from about 5 to about 80, from about 0.5 to about 28, in other embodiments from about 1 to about 25, in other embodiments from about 2 to about 20, and in other embodiments from about 3 to about 15 and in other embodiments from about 15 to about 45 pbw lignin phr (e.g. EPDM).

In one or more embodiments, the vulcanizable compositions used to prepare the one or more layers of the membranes of this invention may include from about 40 to about 100 pbw, in other embodiments from about 50 to about 95 pbw, and in other embodiments from about 55 to about 85 pbw carbon black phr. Certain embodiments may be substantially devoid of carbon black.

In one or more embodiments, the vulcanizable compositions used to prepare the one or more layers of the membranes of this invention may include from about 60 to about 130 pbw, in other embodiments from about 70 to about 100 pbw, and in other embodiments from about 80 to about 98 pbw clay phr. Certain embodiments may be substantially devoid of clay.

In one or more embodiments, the vulcanizable compositions used to prepare the one or more layers of the membranes of this invention may include from 5 to about 60 pbw, in other embodiments from about 10 to about 40 pbw, and in other embodiments from about 20 to about 25 pbw talc phr. Certain embodiments may be substantially devoid of talc.

In one or more embodiments, the vulcanizable compositions used to prepare the one or more layers of the membranes of this invention may include from about 55 to about 95 pbw, in other embodiments from about 60 to about 85 pbw, and in other embodiments from about 65 to about 80 pbw extender phr. Certain embodiments may be substantially devoid of extender.

In one or more embodiments, the vulcanizable compositions used to prepare the one or more layers of the membranes of this invention include from about 12 to about 25 pbw mica per 100 pbw phr. In other embodiments, the membrane includes less than 12 pbw phr mica, and in other embodiments less than 6 pbw mica phr. In certain embodiments, the membrane is devoid of mica.

In one or more embodiments, the vulcanizable compositions used to prepare the one or more layers of the membranes of this invention may include from about 10 to about 100 pbw silica phr. In other embodiments, the vulcanizable compositions include less than 70 pbw silica phr, and in other embodiments less than 55 pbw silica phr. In certain embodiments, the membrane is devoid of silica.

In one or more embodiments, the vulcanizable compositions used to prepare the one or more layers of the membranes of this invention include from about 2 to about 10 pbw homogenizing agent phr. In other embodiments, the membrane includes less than 5 pbw homogenizing agent phr, and in other embodiments less than 3 pbw homogenizing agent phr. In certain embodiments, the membrane is devoid of homogenizing agent.

In one or more embodiments, the vulcanizable compositions used to prepare the one or more layers of the membranes of this invention include from about 2 to about 10 pbw phenolic resin phr. In other embodiments, the membrane includes less than 4 pbw phenolic resin phr, and in other embodiments less than 2.5 pbw phenolic resin phr. In certain embodiments, the membrane is devoid of phenolic resin.

In one or more embodiments, the vulcanizable compositions used to prepare the one or more layers of the membranes of this invention (or one or more layers of a multi-layered membrane) including lignin are devoid or substantially devoid of halogen-containing flame retardants. In one or more embodiments, the membranes or the layers of a membrane including lignin include less than 5 pbw, in other embodiments less than 3 pbw, and in other embodiments less than 0.1 pbw halogen-containing flame retardant phr. In particular embodiments, the membranes of the present invention are substantially devoid of DBDPO.

### Methods of Manufacture

Practice of embodiments of the present invention is not limited by the methods used to prepare the vulcanizable compositions or the roofing membranes of this invention. For example, convention techniques can be employed, which includes preparing the vulcanizable compositions by using conventional batch mixing techniques, calendaring a sheet, fabricating a green membrane, curing the green membrane to form a cured membrane, and then optionally finishing the membrane to ultimately form a roll for shipping.

Conventional rubber mixing, also referred to as rubber compounding, can employ a variety of mixing equipment such as Brabender mixers, Banbury mixers, Sigma-blade mixers, two-roll mills, or other mixers suitable for forming viscous, relatively uniform admixtures. Mixing techniques depend on a variety of factors such as the specific types of polymers used, and the fillers, processing oils, waxes and other ingredients used. In one or more embodiments, the ingredients can be added together in a single shot. In other embodiments, some of the ingredients such as fillers, oils, etc. can first be loaded followed by the polymer. In other embodiments, a more conventional manner can be employed where the polymer added first followed by the other ingredients. These techniques are generally known in the art as disclosed in U.S. Publication Nos. 2014/0373467, 2006/0280892, 2008/0097004, 2016/0221309, which are incorporated herein by reference.

Mixing cycles generally range from about two to about six minutes. In certain embodiments an incremental procedure can be used whereby the base polymer and part of the fillers are added first with little or no process oil, the lignin, the remaining fillers and process oil are added in additional increments. In other embodiments, part of the EPDM can be added on top of the fillers, plasticizers, etc. This procedure can be further modified by withholding part of the process oil, and then adding it later. In one or more embodiments, two-stage mixing can be employed.

The sulfur cure package (sulfur/accelerator) can be added near the end of the mixing cycle and at lower temperatures to prevent premature crosslinking of the EPDM polymer chains. When utilizing a type B Banbury internal mixer, the dry or powdery materials such as the carbon black and non-black mineral fillers (i.e., untreated clay, treated clays, talc, mica, and the like) can be added first, followed by the liquid process oil and finally the polymer (this type of mixing can be referred to as an upside-down mixing technique).

Once mixed, the rubber composition can then be formed into a sheet via calendering. The compositions of the invention can also be formed into various types of articles using other techniques such as extrusion.

Methods also exist for the continuous manufacture of vulcanizable compositions of matter that are useful for forming roofing membranes. In this regard, U.S. Publication No. 2015/0076743 is incorporated herein by reference.

The resultant vulcanizable compositions may be prepared in sheet form in any known manner such as by calendering or extrusion. The sheet may also be cut to a desired dimension. In one or more embodiments, the resulting admixture can be sheeted to thicknesses ranging from 5 to 200 mils, in other embodiments from 35 to 90 mils, by using conventional sheeting methods, for example, milling, calendering or extrusion. In one or more embodiments, the admixture is sheeted to at least 40 mils (0.040-inches), which is the minimum thickness specified in manufacturing standards established by the Roofing Council of the Rubber Manufacturers Association (RMA) for non-reinforced EPDM rubber sheets for use in roofing applications. Membranes of one or more embodiments meet the standards of ASTM D4637 (2021). In other embodiments, the admixture is sheeted to a thickness of about 45 mils, which is the thickness for a large percentage of “single-ply” roofing membranes used commercially. The sheeting can be visually inspected and cut to the desired length and width dimensions after curing. The membranes of the present invention can be optionally reinforced with scrim. In other embodiments, the membranes are devoid of scrim. The skilled person understands that reinforcement can be included into the membrane by sandwiching the fabric between two layers of rubber sheet. Each rubber sheet may derive from the same or different vulcanizable compositions. As noted above, at least one of the rubber layers is prepared from the vulcanizable composition including lignin.

The green membrane is then subjected to curing conditions. This can take place using conventional batch procedures where the membrane is rolled and cured in an oven, optionally under pressure, such as is accomplished within an autoclave. The skilled person understands that efforts must be undertaken to ensure that the membrane does not cure to itself when rolled. For example, the green membrane can be dusted (e.g. talc) or rolled with a curing liner prior to curing. In the alternative, curing can take place continuously using known technologies. In this regard, U.S. Publication Nos. 2015/0076743 and 2001/0027224 are incorporated herein by reference.

Where the membranes of this invention include distinct layers that derive from distinct vulcanizable compositions, the vulcanizable compositions that do not include lignin can be conventional in nature. In this regard, U.S. Pat. Nos. 7,175,732, 6,502,360, 6,120,869, 5,849,133, 5,389,715, 4,810,565, 4,778,852, 4,732,925, and 4,657,958 are incorporated herein by reference.

### Membrane Installation

The membranes of this invention may be unrolled over a roof substructure in a conventional fashion, wherein the seams of adjacent sheets are overlapped and mated by using, for example, an adhesive. The width of the seam can vary depending on the requirements specified by the architect, building contractor, or roofing contractor, and they thus do not constitute a limitation of the present invention. Seams can be joined with conventional adhesives such as, for instance, a butyl-based lap splice adhesive, which is commercially available from Firestone Building Products Company as SA-1065. Application can be facilitated by spray, brush, swab or other means known in the art. Also, field seams can be formed by using tape and companion primer such as QuickSeam™ tape and Quick Prime Plus primer, both of which are commercially available from Holcim Building Envelope of Nashville, TN.

Also, as is known in the art, these membranes can be secured to the roof substructure by using, for example, mechanical fasteners, adhesives (which are often employed to prepare a fully-adhered roofing system), or ballasting. In particular embodiments, the membranes of the present invention can be formed into a composite by applying a layer of pressure-sensitive adhesive (e.g. UV-curable adhesive) as disclosed in U.S. Pat. Nos. 10,065,394, 10,132,082, 10,260,237, and 10,370,854. Furthermore, the membranes of this invention are useful in combination with insulation or coverboards or in composite boards as disclosed in U.S. Pat. No. 7,972,688, which is incorporated herein by reference. It is also contemplated to use the concepts of the present invention in EPDM flashings such as those disclosed in U.S. Pat. No. 5,804,661, which is also incorporated herein by reference.

### Roof System

As indicated above, the membranes of the present invention can be used to create a roof system. These roof systems may include flat or low-slope roofing system. Sloped roof systems typically have a slope of at least 0.25:12 (rise over run), and can include roofs with slope of 1:12, or 2:12 (low sloped), or 3:12, or 5:12.

Exemplary roof systems can be understood with reference to FIG. 1, which shows roofing system 30 including a roof deck 32, an insulation layer 34, an optional high cover board layer 36, and a membrane layer 38. As shown, membrane layer 38 forms the outermost element of system 30, with cover board layer 36 disposed below the membrane, insulation layer 34 disposed below cover board layer 36, and insulation layer 34 disposed above deck 32 .

Practice of this invention is not limited by the selection of any particular roof deck. Accordingly, the roofing systems of this invention can include a variety of roof decks including both combustible and non-combustible decks. Exemplary roof decks include concrete pads, steel decks, wood beams, and foamed concrete decks.

Practice of the invention is not necessarily limited by the selection of insulation layer 34 or cover board layer 36. For example, insulation layer 34 can include polyisocyanurate foam, which may be provided as board stock. In this respect, U.S. Publication Nos. 2004/0082676, 2004/0102537, and 2022/0049063 are incorporated herein by reference. Likewise, cover board layer 36 can include a variety of materials include wood strand board, gypsum, perlite, and high-density foam such as polyisocyanurate board. In this respect, U.S. Publication Nos. 2006/0179749 and 2001/0214387 are incorporated herein by reference.

The various layers of system 30 can be secured to the deck by using various known techniques. For example, in one or more embodiments, one or more of the layers can be mechanically fastened to roof deck 32. In lieu or in combination therewith, one or more layers can be adhesively secured to the layer disposed immediately below. For example, insulation layer 34 and/or cover board layer 36 can be mechanically fastened and then membrane layer 38 can be adhesively fastened.

### Membrane and System Performance Standards

In one or more embodiments, the membranes of the invention can be used to create a Class A roof system over a non-combustible deck pursuant to ASTM E108 (2020). In one or more embodiments, the Class A roof system has a slope of greater than or equal to 0.25:1:12, in other embodiments greater than or equal to 2:12, in other embodiments greater than 3:12, and in other embodiments greater than 5:12. In these or other embodiments, the membranes can be used to create a Class A roof system over a combustible deck or non-combustible deck pursuant to ASTM E108 (2020). In one or more embodiments, the Class A roof system has a slope of greater than or equal to 0.25:12 in other embodiments greater than or equal to 0.5:12, in other embodiments greater than or equal to 1:12, and in other embodiments greater than or equal to 2:12.

In one or more embodiments, the membranes of the present invention meet the performance standards of ASTM D 4637.

In order to demonstrate the practice of the present invention, the following examples have been prepared and tested. The examples should not, however, be viewed as limiting the scope of the invention. The claims will serve to define the invention.

### EXAMPLES

### Examples 1-5

Five rubber formulations were prepared and tested as provided below. The formulations were mixed by employing a two-step mixing procedure. The lignin that was used was obtained as kraft lignin under the name BioChoice® Lignin from Domtar Corporation and was characterized by a water content of about 35%. The lignin was dried and ground to a particle size of D₉₀ of less than 100 μm.

Generally, the formulations included EPDM, carbon black, clay, optionally kraft lignin, process oil, zinc oxide, stearic acid sulfur and an accelerator package. The ingredients were held constant in each sample except as provided in Table I along with the results of various tests that were performed.

TABLE I

| | | | | | |
|---|---|---|---|---|---|
| Sample | 1 | 2 | 3 | 4 | 5 |

Variable Ingredients (phr)

| | | | | | |
|---|---|---|---|---|---|
| Carbon Black | 63 | 63 | 48 | 63 | 48 |
| Clay | 121.3 | 106.3 | 121.3 | 91.3 | 106.3 |
| Kraft Lignin | — | 15 | 15 | 30 | 30 |

Mooney Scorch @ 135° C.

| | | | | | |
|---|---|---|---|---|---|
| Min. Viscosity | 52.5 | 48.6 | 43.5 | 46.6 | 42.1 |
| (MU) | | | | | |
| T5 (minutes) | 26.1 | 27.6 | 35.1 | 26.4 | 32.0 |

RPA (MDR mimic) @ 160° C.

| | | | | | |
|---|---|---|---|---|---|
| ML (dNm) | 2.28 | 2.00 | 1.68 | 2.00 | 1.75 |
| MH (dNm) | 16.77 | 16.2 | 13.69 | 17.48 | 15.18 |
| MH-ML | 14.49 | 14.2 | 12.01 | 15.48 | 13,43 |
| t′10 (minutes) | 10.03 | 10.03 | 11.19 | 8.86 | 10.29 |
| t′90 (minutes) | 44.12 | 45.31 | 46.28 | 44.7 | 46.12 |

Tensile (unaged)

| | | | | | |
|---|---|---|---|---|---|
| 100% Modulus | 386 | 412 | 304 | 401 | 333 |
| (psi) | | | | | |
| 300% Modulus | 893 | 840 | 576 | 766 | 590 |
| (psi) | | | | | |
| Tensile | 1640 | 1450 | 1360 | 1370 | 1330 |
| Strength (psi) | | | | | |
| Elongation (%) | 574 | 576 | 699 | 579 | 687 |

Die C Tear (unaged)

| | | | | | |
|---|---|---|---|---|---|
| Maximum | 209 | 202 | 197 | 219 | 201 |
| Load/Thickness | | | | | |
| (lb f/in) | | | | | |
| Shore A | 67.7 | 69.8 | 64.7 | 69.5 | 67.1 |
| Hardness | | | | | |
| Specific Gravity | 1.3008 | 1.2757 | 1.2876 | 1.2506 | 1.2593 |

The processing properties of each composition were evaluated within a Rubber Processing Analyzer set at 160° C. for 60 minutes at 100 cycles per minute and 0.5°. The analyzer was set to mimic a moving die Rheometer (MDR) at 1.1. Tensile properties were determined in accordance with ASTM D412 (2021), and tear properties were determined in accordance with ASTM D624 (2020). Shore A hardness was determined according to ASTM D2240-15 (2021) and Specific Gravity was determined according to ISO 2781 (2018).

### Examples 6-10

Five additional rubber formulations were prepared using similar materials and techniques as used in Examples 1-5. The relevant ingredients and the resultant compound and membrane properties are set forth in Table II below. As indicated in the table, Samples 9 and 10 employed alkyl ketene dimer, which was believed to modify the kraft lignin. The samples were also tested for flame resistance using techniques designed to mimic ASTM E108 (2020).

TABLE II

| | | | | | |
|---|---|---|---|---|---|
| Sample | 6 | 7 | 8 | 9 | 10 |

Variable Ingredients (phr)

| | | | | | |
|---|---|---|---|---|---|
| Carbon Black | 63 | 63 | 63 | 63 | 63 |
| Clay | 121.3 | 106.3 | 91.3 | 91.3 | 91.3 |
| Kraft Lignin | 0 | 15 | 30 | 30 | 30 |
| Alkyl Ketene | 0 | 0 | 0 | 8 | 12 |
| Dimer | | | | | |

Mooney Scorch @ 135° C.

| | | | | | |
|---|---|---|---|---|---|
| Min. Viscosity | 48.5 | 47.35 | 48.01 | 38.32 | 34.16 |
| (MU) | | | | | |
| T5 (minutes) | 20.62 | 23.57 | 23.1 | 29.23 | 31.68 |

RPA (MDR mimic) @ 160° C.

| | | | | | |
|---|---|---|---|---|---|
| ML (dNm) | 1.95 | 1.72 | 1.96 | 1.53 | 1.44 |
| MH (dNm) | 16.59 | 17.17 | 16.79 | 14.11 | 13.34 |
| MH-ML | 16.64 | 15.45 | 14.83 | 12.58 | 11.90 |
| t′10 (minutes) | 8.72 | 8.23 | 7.19 | 7.22 | 7.56 |
| t′90 (minutes) | 42.51 | 43.14 | 41.94 | 42.57 | 43.18 |

Tensile (unaged)

| | | | | | |
|---|---|---|---|---|---|
| 100% Modulus | 322 | 381 | 348 | 378 | 397 |
| (psi) | | | | | |
| 300% Modulus | 831 | 815 | 740 | 736 | 716 |
| (psi) | | | | | |
| Tensile Strength | 1627 | 1497 | 1267 | 1180 | 1213 |
| (psi) | | | | | |
| Elongation (%) | 599 | 712 | 687 | 536 | 569 |

Die C Tear (unaged)

| | | | | | |
|---|---|---|---|---|---|
| Maximum | 204.5 | 232.7 | 226.6 | 230.9 | 232.8 |
| Load/ | | | | | |
| Thickness | | | | | |
| (lb f/in) | | | | | |
| Shore A | 71.8 | 74.2 | 74.6 | 77.8 | 78.2 |
| Hardness | | | | | |
| Specific | 1.3042 | 1.2790 | 1.2536 | 1.2457 | 1.2431 |
| Gravity | | | | | |

Spread of Flame

| | | | | | |
|---|---|---|---|---|---|
| Spread of | 3.00 | 1.75 | 4.75 | 2.13 | 4.75 |
| Flame (in) | | | | | |
| Weight Loss | 5.55 | 3.42 | 14.41 | 4.86 | 18.08 |
| (grams) | | | | | |

Various modifications and alterations that do not depart from the scope and spirit of this invention will become apparent to those skilled in the art. This invention is not to be duly limited to the illustrative embodiments set forth herein.

What is claimed is:

1. A roof system comprising:
(i) a roof deck; and
(ii) a membrane secured to the roof deck, where the membrane is an EPDM membrane including at least two cured layers of EPDM rubber, where at least one of the at least two cured layers includes lignin dispersed therein.

2. The roofing system of claim 1, where the at least one layer including the lignin includes from about 0.5 to about 30 parts by weight lignin per 100 parts by weight rubber.

3. The roofing system of claim 1, where the at least one layer including the lignin includes from about 1 to about 20 parts by weight lignin per 100 parts by weight rubber.

4. The roofing system of claim 1, where the at least two cured layers of EPDM rubber are sulfur cured.

5. The roofing system of claim 1, where the at least one layer in which the lignin is dispersed further includes carbon black.

6. The roofing system of claim 1, where the at least one layer in which the lignin is dispersed further includes clay.

7. The roofing system of claim 1, where the lignin has a D₉₀ particle size (ASTM E2651) of less than 300 μm.

8. The roofing system of claim 1, where the lignin is pre-modified lignin.

9. The roofing system of claim 1, where the lignin is reacted with a functionalizing agent in situ during formation of the membrane.

10. The roofing system of claim 1, where the membrane meets the performance standard of ASTM D4637 (2021).

11. The roofing system of claim 1, where the membrane has a thickness of from about 20 to about 100 mils.

12. The roof system claim 1, where the roof system is a Class A roof system according to ASTM E108 (2020).

13. The roof system of claim 12, where the roof system has a slope of 0.25:12 or more.

14. A roofing membrane comprising:
a cured EPDM rubber matrix having lignin dispersed therein.

15. A method of forming a roofing membrane; the method comprising:
(i) preparing a vulcanizable composition including EPDM rubber and from about 0.5 to about 30 parts by weight lignin per 100 parts by weight rubber;
(ii) forming the vulcanizable composition into a green membrane sheet; and
(iii) curing the green membrane sheet.
